(19) United States
(12) Patent Application Publication
(10) Pub. No.: US 2015/0034389 A1
(43) Pub. Date: Feb. 5, 2015

(54) WATER-BASED DRILLING FLUID WITH TANNIN ADDITIVE FROM C. CORIARIA

(71) Applicant: Intevep, S.A., Caracas (VE)

(72) Inventor: Miguel Angel Perez, Edo. Miranda (VE)

(73) Assignee: Intevep, S.A., Caracas (VE)

(21) Appl. No.: 13/958,711

(22) Filed: Aug. 5, 2013

(51) Int. Cl. C09K 8/04; E21B 21/00

(52) U.S. Cl. CPC C09K 8/04; E21B 21/00
USPC 175/65; 507/106

(57) ABSTRACT

A conditioned, water-based drilling fluid including water-based drilling fluid; and unmodified vegetable tannin comprising hydrolysable tannin.

### BACKGROUND OF THE INVENTION

The invention relates to drilling fluids and, more particularly, to a drilling fluid with an additive which acts as a thinner and conditioning agent to reduce viscosity, yield point and gel strength of the drilling fluid as desired.

Drilling fluids are widely used for drilling operations to create subterranean wells, for example from a surface location to a subterranean formation which may bear hydrocarbons to be produced through the well. During the course of drilling, a drill bit is rotated in the well bore and drilling fluids are circulated through the well to lubricate the drill string and the drill bit and also to carry cuttings from the formation at the location of the drill bit to the surface. In addition, the drilling fluid can serve to balance hydrostatic pressure encountered in various formations during drilling and serves numerous other purposes.

Thinners are frequently used in water-based drilling fluids for reducing their viscosity, yield point and gel strength when needed. Such thinners include chemical treatments with substances such as lignites, lignosulfonates, and modified tannins. These thinners generally have, as a common characteristic, an anionic charge. These anions are attracted on the edge surfaces of clay particles and neutralize charges and electronically compensate for the attractive charges between the particles, thereby decreasing the tendency of the fluid to form a gel structure, and decreasing plastic viscosity.

The modified tannins frequently used are from sources including Quebracho, mimosa, baloneea, and chestnut, and these modified tannins are effective deflocculants of water-based drilling fluids. These modified tannins are effective even when the drilling fluid is contaminated with other substances such as gypsum, cement, lime and salts, as these contaminants typically cause problems with respect to viscosity, yield point and gel strength. Unfortunately, the modified tannins referenced above, although widely used, have environmentally hazardous effects. The typical modifications involve modification with heavy metals such as chrome-tannates, fero-tannates, and stannus-tannates in order to improve their performance as a deflocculant at higher temperatures, and to provide more tolerance to salt and calcium contamination. However, none of these materials is environmentally acceptable.

It is clear that the need exists for a suitable additive for a drilling fluid which addresses the various issues with respect to viscosity, yield point and gel strength of the drilling fluid without causing the aforesaid environmentally hazardous effects. It is therefore the goal of the present invention to provide an additive for drilling fluids and a conditioned drilling fluid containing the additive which is effective at controlling viscosity, yield point and gel strength while also being environmentally friendly.

Other objects and advantages will appear hereinbelow.

### SUMMARY OF THE INVENTION

In accordance with the present invention, the foregoing has been attained. Specifically, an additive for drilling fluids is provided which is based on unmodified tannins obtained from Caesalpinia coriaria or C. coriaria (divi-divi) which is a native Leguminosae widely distributed throughout Venezuela. A dry fraction of this particular species, namely a dry fraction extracted from the fruit pods of C. Coriaria, has shown to have excellent properties as a deflocculant and conditioning agent in water-based drilling fluids. This vegetable tannin has a very high content of hydrolysable tannins.

Therefore, in accordance with the present invention, a conditioned water-based drilling fluid is provided which comprises water-based drilling fluid and unmodified vegetable tannin comprising hydrolysable tannins.

In further accordance with the invention a method for drilling a subterranean well is provided, comprising the steps of: operating a drill bit in a well in the presence of a conditioned, water-based drilling fluid, wherein the drilling fluid comprises water-based drilling fluid, and unmodified vegetable tannin comprising hydrolysable tannins.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

A detailed description of preferred embodiments of the present invention follows, with reference to the attached drawings, wherein:

FIG. 1 schematically illustrates a drilling operation in accordance with the present invention;

FIG. 2. presents the UV-DIS spectra of tannins in accordance with the present invention;

FIG. 3 presents the FT-IR spectra of tannins in accordance with the present invention;

FIG. 4 illustrates the comparative spectrum of commercial modified tannins versus standard tannic acid;

FIG. 5 illustrates rheological readings at room temperature versus shear rate for different drilling fluids treated with divi-divi tannins;

FIG. 6 illustrates rheological readings at room temperature versus shear rate for different drilling fluids treated with reference tannins;

FIG. 7 illustrates rheological readings at room temperature versus shear rate for base drilling fluids treated with divi-divi tannins;

FIG. 8 illustrates rheological readings at room temperature versus shear rate for base drilling fluids treated with reference tannins;

FIG. 9 illustrates initial plastic viscosity and initial yield point for base fluid, contaminated base fluid and base fluid treated with divi-divi tannins in different quantities;

FIG. 10 illustrates initial plastic viscosity and initial yield point for base fluid, contaminated base fluid and base fluid treated with reference tannins in different quantities;

FIG. 11 illustrates initial plastic viscosity and initial yield point for base fluid, contaminated base fluid and base fluid treated with divi-divi tannins in different quantities after aging for 16 hours at 150° F.;

FIG. 12 illustrates initial plastic viscosity and initial yield point for base fluid, contaminated base fluid and base fluid treated with reference tannins in different quantities after aging for 16 hours at 150° F.;

FIG. 13 shows the initial gel strength for base fluid, contaminated base fluid and base fluids treated with divi-divi tannins in different amounts in accordance with the present invention;

FIG. 14 shows the initial gel strength for base fluid, contaminated base fluid and base fluids treated with divi-divi tannins in different amounts;

FIG. 15 illustrates gel strength after 16 hours aging at 150° F. for base fluids, contaminated base fluids and base fluids having been treated with divi-divi tannins in accordance with the present invention; and

FIG. 16 illustrates gel strength after 16 hours aging at 150° F. for base fluids, contaminated base fluids and base fluids having been treated with reference tannins.

### DETAILED DESCRIPTION

The invention relates to drilling fluids and an additive for conditioning a drilling fluid for adjusting and generally reducing the viscosity, yield point and gel strength of the drilling fluids. In accordance with the present invention, the additive is an unmodified tannin obtained from the tannin fruit pods of C. Coriaria (divi-divi). These tannins have chemical characteristics that do not require modification to produce excellent performance as deflocculants and the process for extracting these tannins is a dry process. The tannic acid contained in the tannins is a particularly important aspect, particularly tannic acid which is classified as hydrolysable tannins, such as gallotannins and ellagitannins. Hydrolysable tannins have been found to be abundant in tannins obtained from the fruit pods of C. Coriaria. Spectrophotometric UV-visible analysis indicates a tannins content from C. Coriaria is about 65-70% as tannic acid. This tannic acid is classified as hydrolysable tannins as discussed above.

The unmodified tannins in accordance with the present invention are found to be an extremely useful additive to water-based drilling fluid to produce conditioned drilling fluid which has desirable properties with respect to reduction of viscosity, yield point and gel strength, all as will be further demonstrated further below.

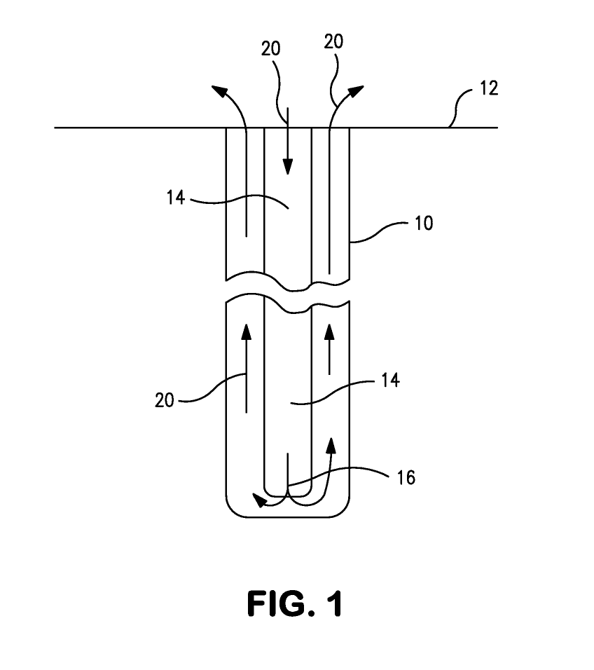

FIG. 1 schematically illustrates a basic drilling process as background for the drilling fluids and additive for drilling fluids of the present invention. As shown schematically, a well 10 extending from surface 12 into subterranean formations is drilled with a drill string 14 having a drill bit 16. Drilling fluid is typically circulated through the well, for example by being fed through drill string 14 and back up through an annular space between drill string 14 and the well bore, and this drilling fluid serves to lubricate the drill string and drill bit, and to carry cuttings from the formation to the surface. The circulating drilling fluid is schematically illustrated by arrows 20.

As mentioned above, the drilling fluid additive of the present invention in the form of unmodified tannins extracted from the fruit pods of C. Coriaria produces excellent results in reduction of viscosity, yield point and gel strength of the drilling fluid, and is far more environmentally friendly than the typical modified tannins as discussed above.

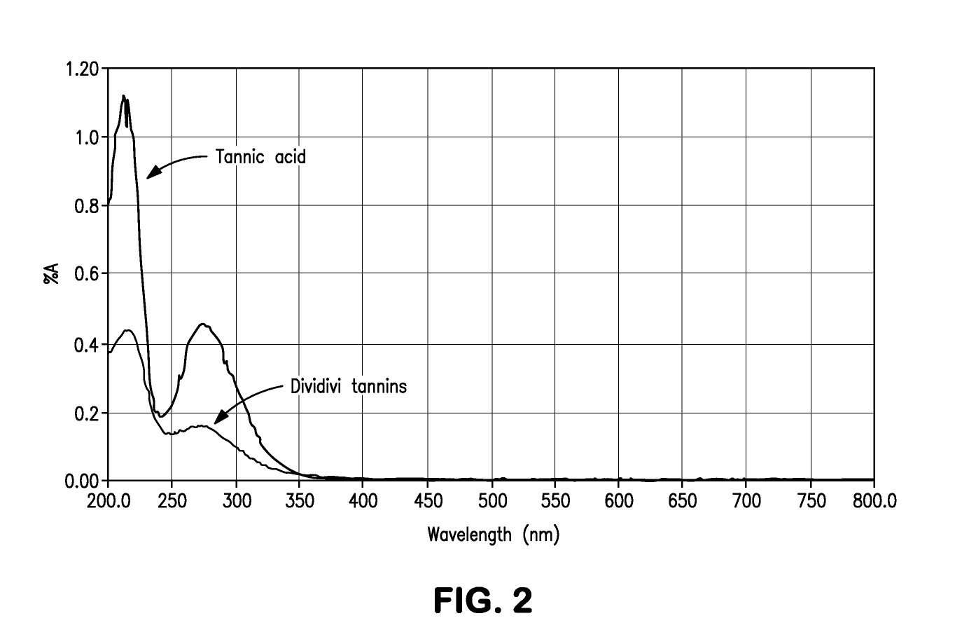

As mentioned previously, the tannic acid content of the tannins obtained from C. Coriaria is a particularly advantageous and desirable quality of these specific tannins. FIG. 2 illustrates the UV-DIS spectra of tannic acid and tannins from C. Coriaria, which are also referred to herein as divi-divi tannins. The aligned spike in acid number percentage (%A) between the divi-divi tannins and tannic acid confirms that divi-divi tannins contain about 65-70% of tannins as tannic acid.

The dry process for extracting tannins from C. Coriaria fruit pods also involves separation of the divi-divi tannins from the various dry process materials, and grain size distribution has been found according to the invention to be of critical importance in obtaining suitable tannins. Specifically, following a typical dry process, the size range of between 15 μm and 150 μm, preferably between 45 μm and 75 μm, produces a fraction of the dried grain materials having the highest content of hydrolysable tannins.

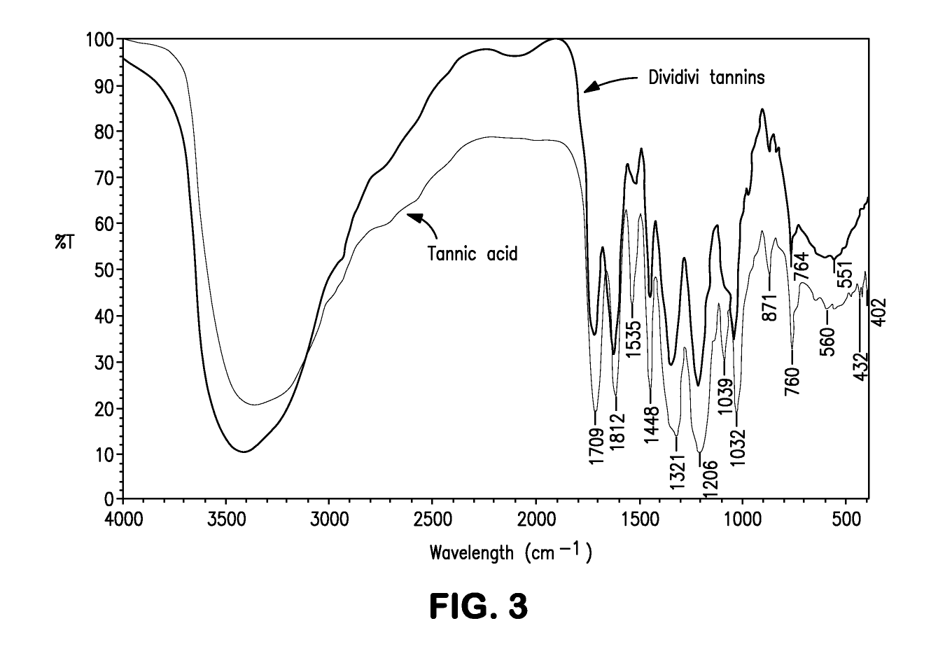

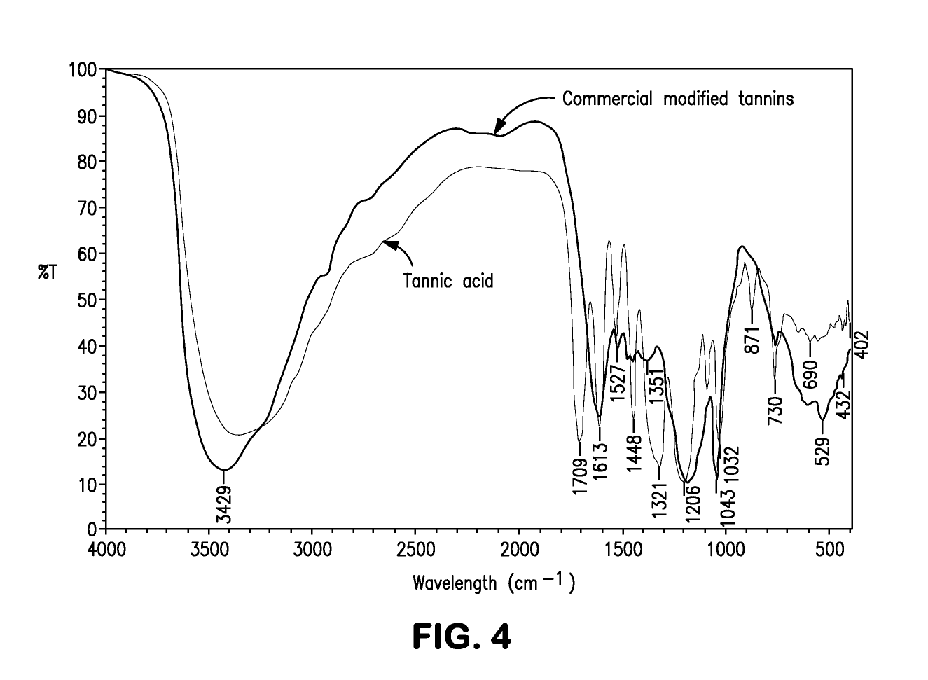

FT-IR spectra of tannins were taken specifically of the divi-divi tannins, commercially modified tannins and straight tannic acid, and these spectra are illustrated in FIGS. 3 and 4. The spectra show that in the regions of 3500-3250 cm⁻¹ and in 1800-700 cm⁻¹ there is a close match between the unmodified divi-divi tannins and tannic acid, and that this close match is similar to the commercially modified tannins illustrated in FIG. 4. These regions point to the presence of -OH groups (phenols) with different types of associations, and that the materials include bands of aromatic structures substituted by carboxylic and phenolic groups. There is a structural similarity between the divi-divi tannins and 90% pure tannic acid (as illustrated in FIG. 3) along the entire spectrum. This contrasts to the same comparison made to the spectra for commercial modified tannins and tannic acid (FIG. 4). The coincidence between the IR spectral bands of the divi-divi sample and the tannic acid was 82%, and this similarity is consistent with the highest content of hydrolysable tannins in tannic acid. This indicates the presence of groups of similar compounds between these two types of tannins, such as pyrogallol structures. In contrast, superimposed IR spectral bands of the commercial tannin versus tannic acid spectrum show percentage of overlap of only 32%, indicating that the commercial tannin contains less hydrolysable tannins, and therefore, is more enriched in condensed tannins.

The similarity between divi-divi tannins and tannic acid as shown in FIG. 3 suggests the predominance of gallotannin type structures in the divi-divi tannins while, catechinic structures predominate in the commercial tannins of FIG. 4. This difference allows the unmodified divi-divi tannins to act as a natural thinner as is, without the need for any environmentally undesirable modifications. The performance as a thinner was evaluated using the standard ISO10416:2008, which is a deflocculation and thinner evaluation test. This laboratory test is designed to evaluate the relative effectiveness of a thinner in a high solid content suspension (which is typical of a drilling fluid). This test was used to evaluate a drilling fluid with unmodified tannins from C. Coriaria according to the invention as compared to the same fluid treated with a reference thinner. The thinning efficiency (e) was calculated and expressed as a percentage of performance of the divi-divi tannins relative to the performance of reference modified tannins. The results of this testing are shown in Table 1.

TABLE 1

| | Rheological | Performance | Performance | Performance |
|---|---|---|---|---|
| Deflocculant | Properties | at room temperature | at room temperature | at room temperature |
| Tannin | (lb/100 ft²) | (aging before) | (aging after 16 hrs at 150° F.) | (aging after 16 hrs at 150° F.) |
| Reference | YP | 34 | 30 | 92 |
| (modified tannin) | | | | |
| Dividivi | YP | 34 | 30 | 10 |
| Reference | Gel 10 sec/10 min | 25/29 | 21/34 | 55/55 |
| (modified tannin) | | | | |
| Dividivi | Gel 10 sec/10 min | 29/30 | 23/24 | 17/29 |

| | Rheological | | | |
|---|---|---|---|---|
| Efficiency | Properties | (*)Efficiency (e) | Efficiency (e) | Efficiency (e) |
| Evaluation | (lb/100 ft²) | (aging before) | (aging after 16 hrs at 150° F.) | (aging after 16 hrs at 150° F.) |
| Dividivi | YP | 1.0 | 1.0 | 9.2 |
| Dividivi | Gel 10 sec | 0.9 | 0.9 | 3.2 |
| Dividivi | Gel 10 min | 1.0 | 1.4 | 1.9 |

(*)Efficiency = (Pr/Ps). er

Table 1 shows that the divi-divi tannins in accordance with the present invention presented properties as good as or better than the reference modified tannins, and this is significant given that the unmodified tannins of the present invention do not pose the same environmental risks as do the modified reference tannins.

In order to evaluate the divi-divi tannins in accordance with the present invention as a deflocculant, a number of water-based drilling fluids were prepared and then contaminated with a constant amount of gypsum. Yield point and gel values were tested, and these values increased considerably upon contamination with gypsum except for the fluids which were also treated with 1.5 and 3.0 pounds per barrel (ppb) of the divi-divi tannin. Tables 2 and 3 set forth the results of this testing.

TABLE 2

| Formulation | UN | Base | F1 | F2 | F3 | F4 | F5 | F6 |
|---|---|---|---|---|---|---|---|---|
| Water | ml | 150 | 150 | 150 | 150 | 150 | 150 | 150 |
| Bentonite | lb | 200 | 200 | 200 | 200 | 200 | 200 | 200 |
| prehydrated | | | | | | | | |
| Dividivi tannin | lb | 0 | 0 | 0.5 | 0.5 | 1.0 | 1.5 | 3.0 |
| NaOH (adjust at | — | | | | | | | |
| pH = 9.5) | | | | | | | | |
| Gypsum | lb | 0 | 1 | 0 | 1 | 1 | 1 | 1 |
| Barite (D_{L} = 10 lpg) | lb | 55 | 55 | 55 | 55 | 55 | 55 | 55 |

Rheological Properties initial at room temperature

| Rheological readings | UN | Base | F1 | F2 | F3 | F4 | F5 | F6 |
|---|---|---|---|---|---|---|---|---|
| L600 | rpm | 33 | 76 | 43 | 73 | 55 | 19 | 30 |
| L300 | rpm | 19 | 54 | 26 | 52 | 40 | 11 | 20 |
| L200 | rpm | 13 | 45 | 19 | 44 | 34 | 8 | 15 |
| L100 | rpm | 8 | 34 | 11 | 35 | 26 | 6 | 10 |
| L6 | rpm | 1 | 21 | 1 | 21 | 15 | 2 | 5 |
| L3 | rpm | 1 | 22 | 1 | 22 | 16 | 3 | 6 |
| VP | cP | 14 | 22 | 17 | 21 | 15 | 8 | 10 |
| YP | δ(*) | 5 | 32 | 9 | 31 | 25 | 3 | 10 |
| Gels 10 sec/10 min | δ | 1/2 | 33/77 | 2/11 | 38/104 | 30/68 | 7/11 | 10/18 |
| pH | | 9.5 | 9.5 | 9.5 | 9.5 | 9.5 | 9.5 | 9.5 |

Rheological Properties after aging 16 hrs × 150° F. at room temperature

| Rheological readings | UN | Base | F1 | F2 | F3 | F4 | F5 | F6 |
|---|---|---|---|---|---|---|---|---|
| L600 | rpm | 34 | 91 | 61 | 83 | 76 | 14 | 15 |
| L300 | rpm | 19 | 61 | 38 | 57 | 49 | 9 | 9 |
| L200 | rpm | 14 | 49 | 29 | 46 | 38 | 6 | 6 |
| L100 | rpm | 8 | 34 | 18 | 36 | 13 | 4 | 4 |
| L6 | rpm | 2 | 15 | 1 | 41 | 13 | 1 | 1 |
| L3 | rpm | 1 | 16 | 1 | 42 | 14 | 1 | 1 |
| VP | cP | 15 | 30 | 23 | 26 | 27 | 5 | 6 |
| YP | δ(*) | 4 | 31 | 15 | 31 | 22 | 4 | 3 |
| Gels 10 sec/10 min | δ | 1/1 | 23/60 | 3/10 | 54/78 | 23/65 | 3/4 | 2/7 |
| pH | | 9.5 | 9.5 | 9.5 | 9.5 | 9.5 | 9.5 | 9.5 |

(*)δ = lb/100 ft²; bentonite factor 0.1 g dry/g pre-hydrated; solution NaOH = 0.25 g/ml

TABLE 3

| Formulation | UN | Base | F1 | F2 | F3 | F4 | F5 | F6 |
|---|---|---|---|---|---|---|---|---|
| Water | ml | 150 | 150 | 150 | 150 | 150 | 150 | 150 |
| Bentonite prehydrated | lb | 200 | 200 | 200 | 200 | 200 | 200 | 200 |
| Reference tannin | lb | 0 | 0 | 0.5 | 0.5 | 1.0 | 1.5 | 3.0 |
| NaOH | — | | | | | | | |
| (adjust pH = 9.5) | | | | | | | | |
| Gypsum | lb | 0 | 1 | 0 | 1 | 1 | 1 | 1 |
| Barite (D_{L} = 10 lpg) | lb | 55 | 55 | 55 | 55 | 55 | 55 | 55 |

Rheological Properties initial at room temperature

| Rheological readings | UN | Base | F1 | F2 | F3 | F4 | F5 | F6 |
|---|---|---|---|---|---|---|---|---|
| L600 | rpm | 33 | 76 | 34 | 51 | 57 | 55 | 55 |
| L300 | rpm | 19 | 54 | 19 | 37 | 38 | 38 | 38 |
| L200 | rpm | 13 | 45 | 14 | 31 | 32 | 31 | 31 |
| L100 | rpm | 8 | 34 | 8 | 23 | 24 | 23 | 24 |
| L6 | rpm | 1 | 21 | 2 | 15 | 14 | 13 | 14 |
| L3 | rpm | 1 | 22 | 2 | 15 | 15 | 13 | 14 |
| VP | cP | 14 | 22 | 15 | 14 | 19 | 17 | 17 |
| YP | δ(*) | 5 | 32 | 4 | 23 | 19 | 21 | 21 |
| Gels 10 sec/10 min | δ | 1/2 | 33/77 | 2/5 | 28/78 | 26/68 | 22/60 | 24/55 |
| Filtrado API | ml | NA | NA | NA | NA | NA | NA | NA |
| pH | | 9.5 | 9.5 | 9.5 | 9.5 | 9.5 | 9.5 | 9.5 |

Rheological Properties after aging 16 hrs × 150° F. at room temperature

| Rheological readings | UN | Base | F1 | F2 | F3 | F4 | F5 | F6 |
|---|---|---|---|---|---|---|---|---|
| L600 | rpm | 34 | 91 | 41 | 69 | 73 | 72 | 73 |
| L300 | rpm | 19 | 61 | 24 | 45 | 46 | 44 | 46 |
| L200 | rpm | 14 | 49 | 17 | 35 | 35 | 35 | 36 |
| L100 | rpm | 8 | 34 | 10 | 22 | 24 | 22 | 23 |
| L6 | rpm | 2 | 15 | 1 | 8 | 8 | 6 | 7 |
| L3 | rpm | 1 | 16 | 1 | 8 | 8 | 6 | 7 |
| VP | cP | 15 | 30 | 17 | 24 | 27 | 28 | 27 |
| YP | δ(*) | 4 | 31 | 7 | 21 | 19 | 16 | 19 |
| Gels 10 sec/10 min | δ | 1/1 | 23/60 | 1/2 | 14/55 | 12/44 | 10/33 | 12/40 |
| API filter | ml | NA | NA | NA | NA | NA | NA | NA |
| pH | | 9.5 | 9.5 | 9.5 | 9.5 | 9.5 | 9.5 | 9.5 |

(*)δ = lb/100ft²; bentonite factor 0.1 g dry/g pre-hydrated; solution NaOH = 0.25 g/ml

Contamination of the fluids with gypsum created fluid flocculation conditions without needing to increase the pH, which helps to better study the performance of a system which might otherwise be sensitive to changes in pH, by creating a single variable, namely, deflocculation and not the pH.

In the formulation used for these tests, the reference material was a commercial modified tannin DESCO from Drilling Specialties Company, having deflocculant functionality as recognized in commercial operations with water-based drilling fluids.

Table 2 above shows water based drilling fluid contaminated with 1 ppb of gypsum, and the same base fluid treated with 0, 0.5, 1.0, 1.5 and 3.0 ppb of divi-divi tannin. Rheological readings are also presented initially and after aging at 16 hours and a temperature of 150° F., and excellent rheological properties are exhibited even after contamination with 1.0 ppb of gypsum, when 1.5 and 3.0 ppb divi-divi tannins are also included.

Table 3 shows that performance of the reference tannin with respect to a gypsum-contaminated drilling fluid was not nearly as effective.

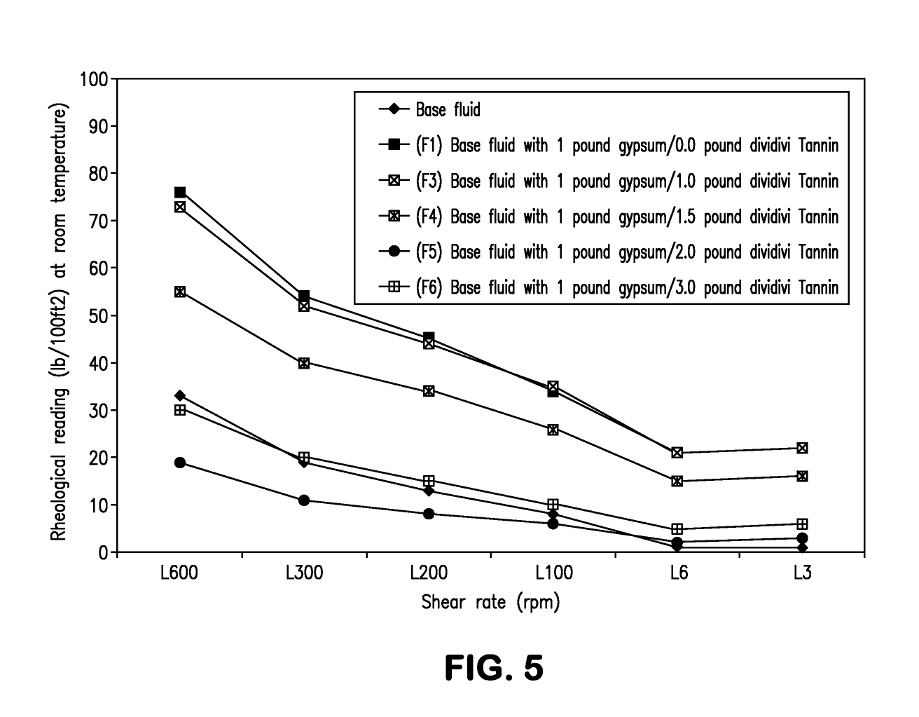

The rheological behavior in accordance with the present invention was also evaluated in its reaction to different shear rates both before and after aging. The same base fluid discussed above was evaluated when contaminated with 1 ppb of gypsum and varying amounts of divi-divi tannin. The results of this testing are presented in FIG. 5, which shows much higher rheological readings for the contaminated base fluid (F1) as compared to the base fluid, and which then shows gradually decreasing rheological readings as the amount of divi-divi tannin added is increased from 1.0 to 3.0 ppb. It is noted from FIG. 5 that for many of the shear rates tested, the base fluid when contaminated with 1 ppb of gypsum and having 2.0 ppb of divi-divi tannin had more favorable rheological readings than the base fluid prior to contamination.

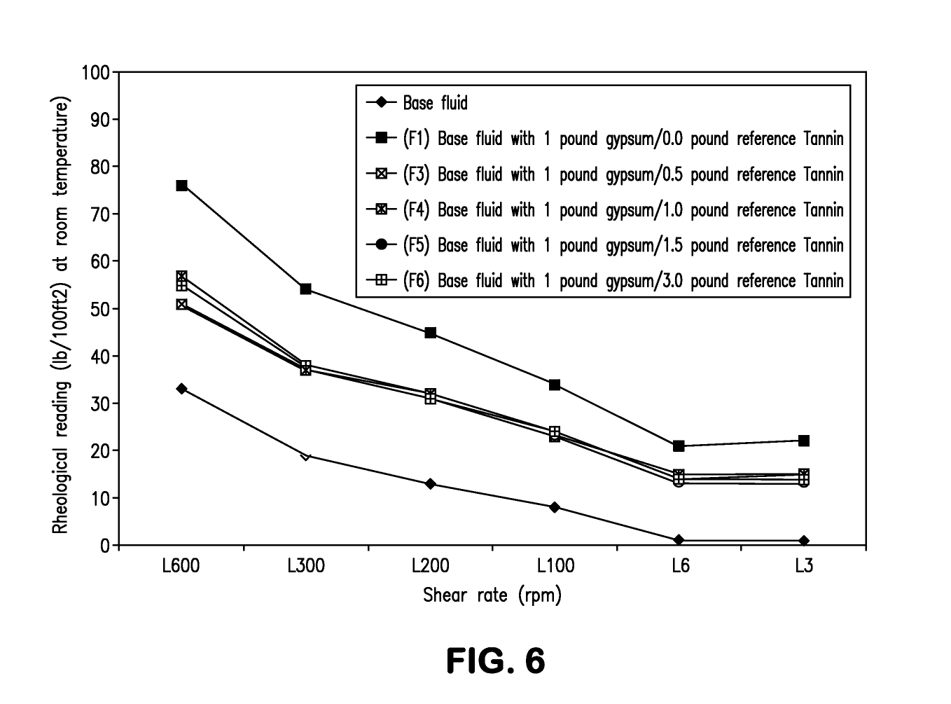

Referring to FIG. 6, the same tests as discussed with respect to FIG. 5 were carried out utilizing reference tannin, rather than the divi-divi tannin of the present invention, and as can be seen, the values obtained for 0.5-3.0 ppb of reference tannin are all closely grouped together, and substantially higher than the values obtained utilizing the divi-divi tannin in accordance with the present invention and as shown in FIG. 5.

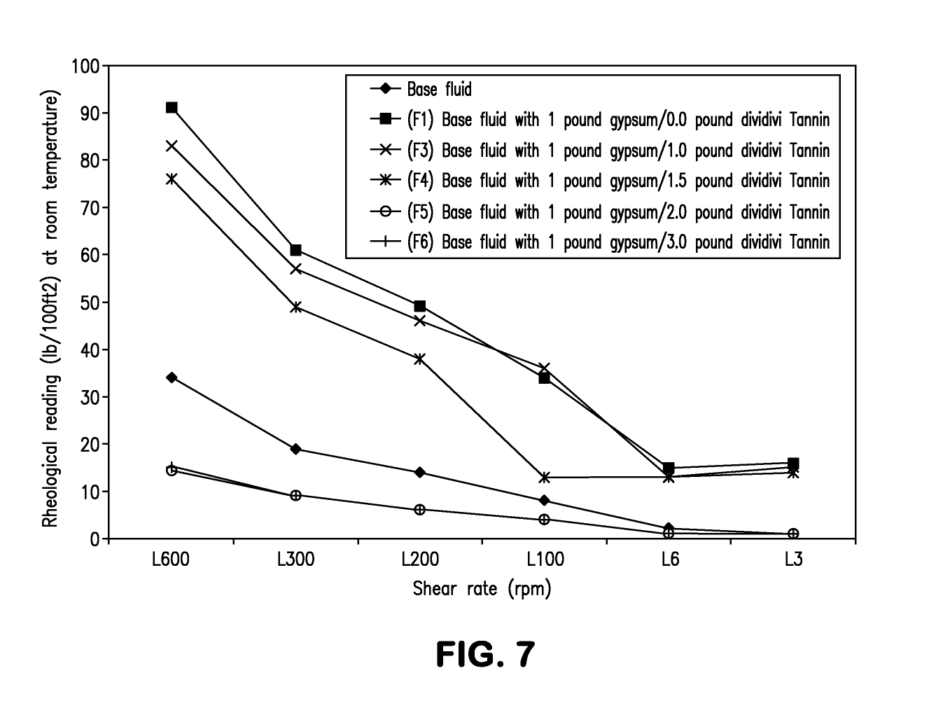

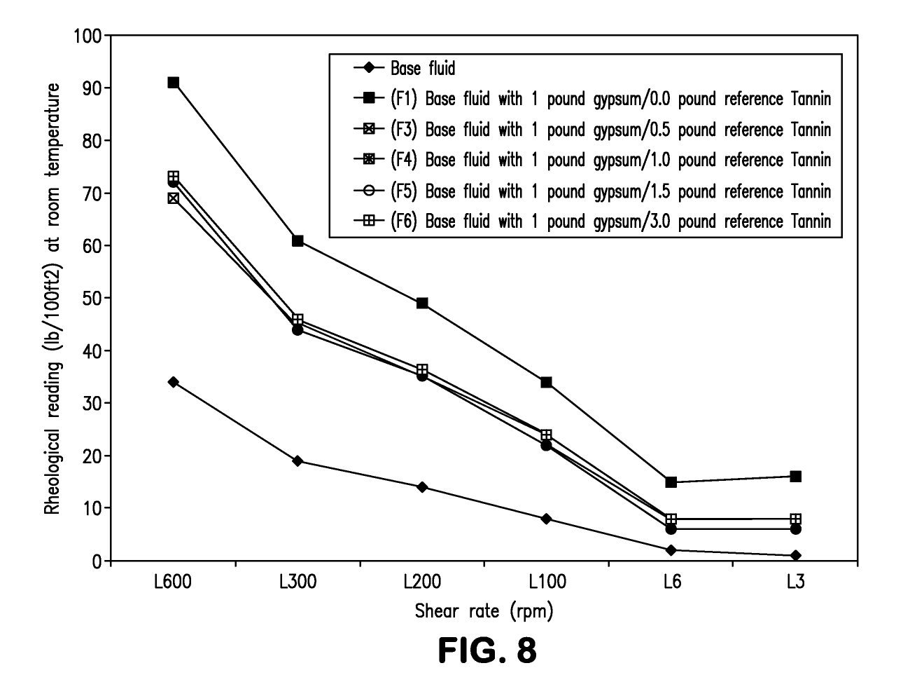

FIGS. 7 and 8 show the same rheological reading for the same fluids as presented in FIGS. 5 and 6, but after aging for approximately 16 hours. FIG. 7 showing the results using divi-divi tannin in accordance with the present invention and shows a dramatic increase in rheological reading from the base fluid to the contaminated base fluid, and improvement in these values when divi-divi tannin in accordance with the present invention is added. Further, when 2.0 and 3.0 ppb of divi-divi tannin were used, the resulting values were substantially lower than even the initial base fluid prior to contamination with gypsum. Thus, the divi-divi tannin in accordance with the present invention provides excellent rheological behavior of the fluid even after aging.

Referring now to FIG. 8, the same values are shown for a reference tannin and it can be seen that the reference tannin behaves similarly prior to aging in that the reference tannin does provide some benefit, but the amount of reference tannin used does not make a substantial difference, and all values are substantially higher than would be desired.

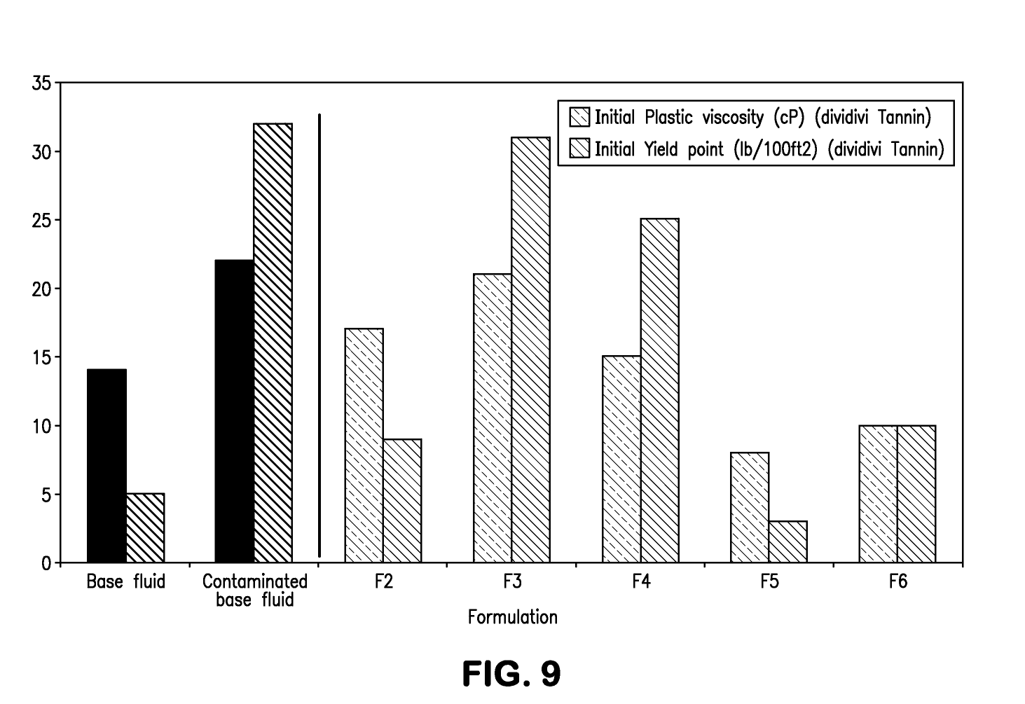

With respect to yield point and plastic viscosity, these values were also taken both before and after aging for fluids treated with divi-divi tannins in accordance with the present invention and for fluids treated with a reference tannin. The results of this testing are presented in FIGS. 9-12.

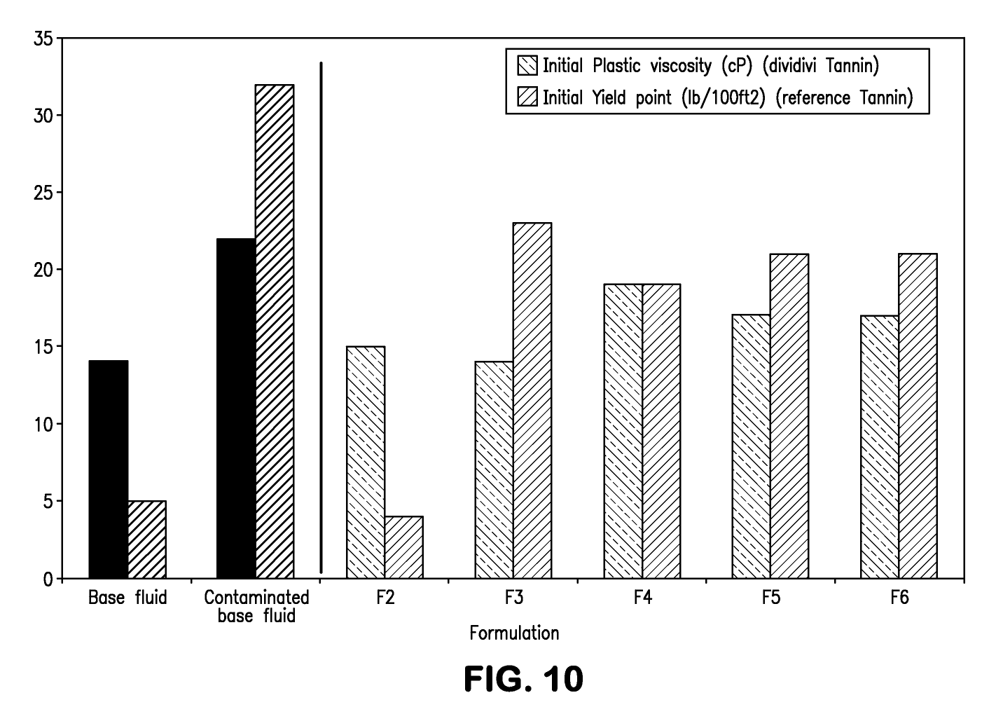

FIG. 9 shows initial plastic viscosity and initial yield points as the left and right columns respectively, and shows values obtained with a fluid treated with divi-divi tannin in accordance with the present invention. The fluids tested correspond to fluids F2, F3, F4, F5 and F6 as discussed above, and these fluids have increasing amounts of divi-divi tannin. The fluids having low concentrations of tannin (0.5 and 1.0 ppb) showed low performance in deflocculant behavior, as illustrated by the results shown for fluids F2 and F3 in FIGS. 9 an 10. By contrast, the formulations having higher concentration of tannins (1.5 and 3.0 ppb), fluids F5 and F6 in the figures, showed much better rheological properties in FIG. 9 for the fluid using divi-divi tannin in accordance with the present invention as compared to FIG. 10 for the fluids prepared using reference tannins.

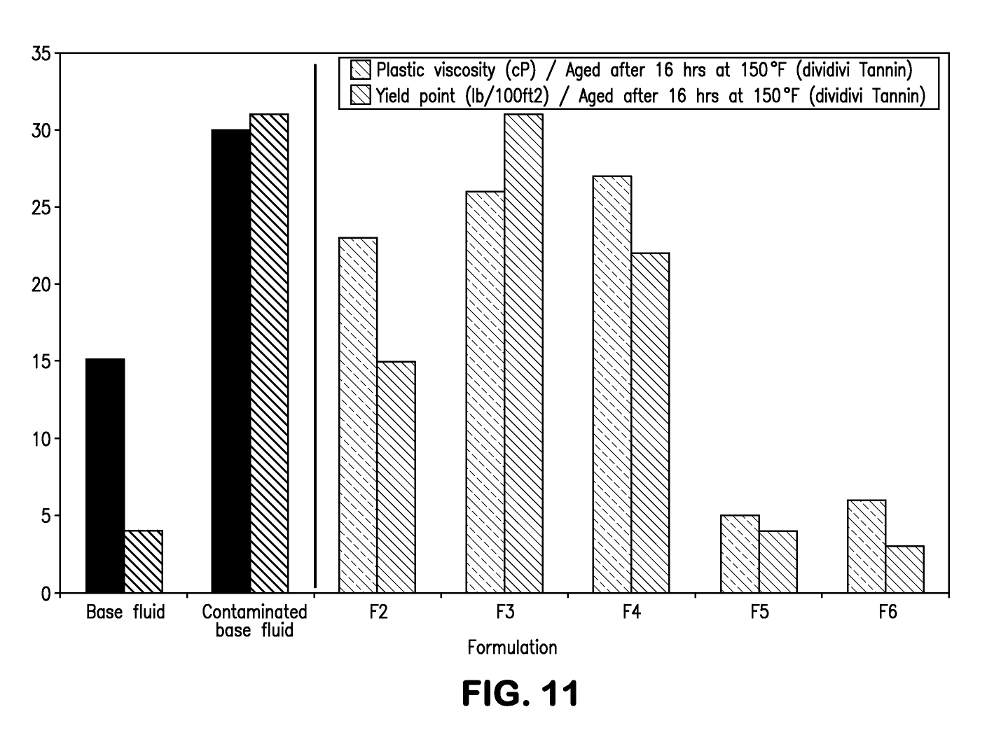

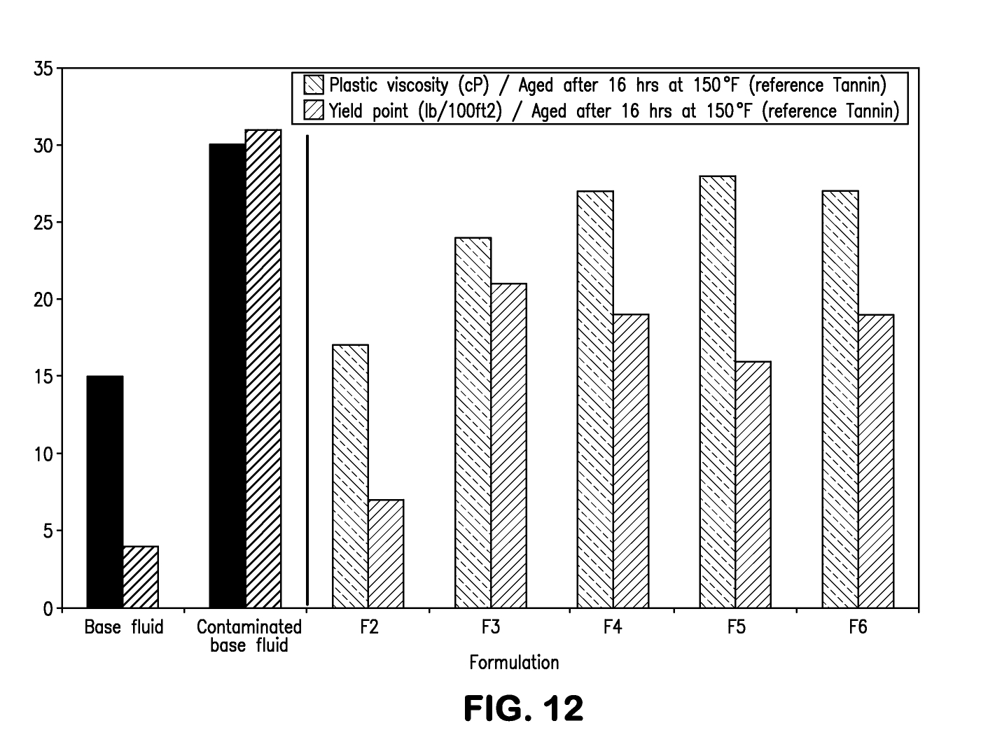

The same values were taken after aging for 16 hours at 150° F., and the results of these tests are shown in FIGS. 11 and 12. In these figures as well, excellent values are obtained with the divi-divi tannin in accordance with the present invention at 1.5 and 3.0 ppb (fluids F5 and F6, FIG. 11).

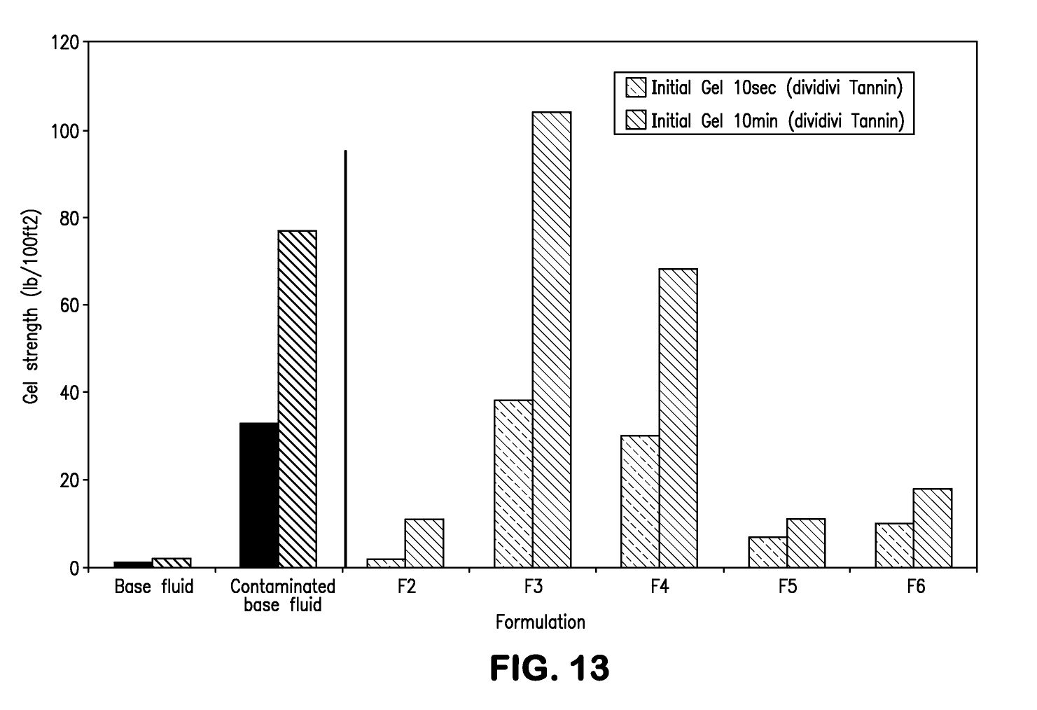

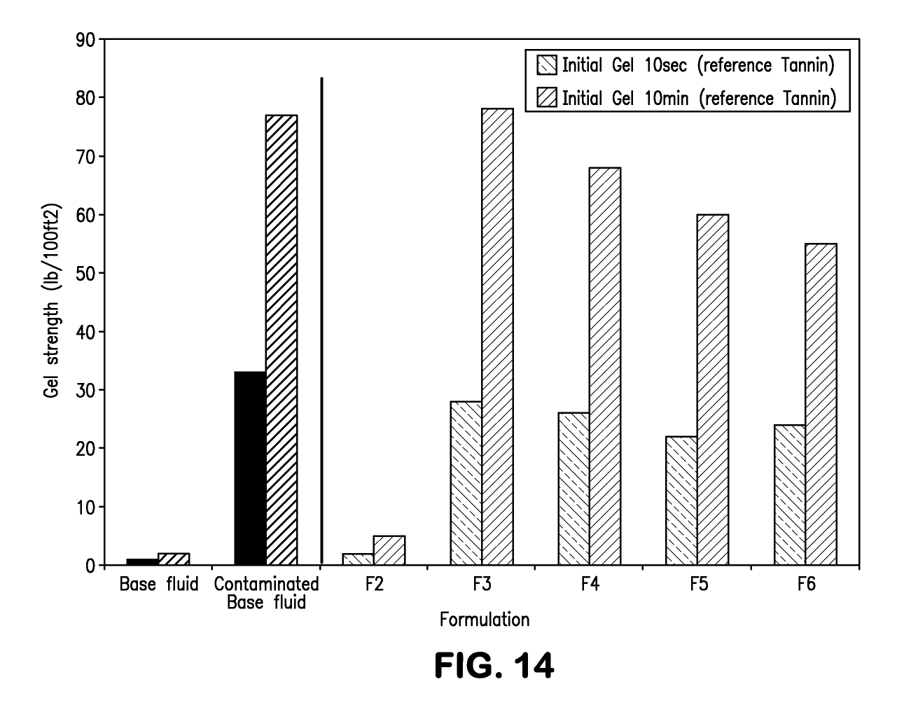

Next, in further evaluating the fluid in accordance with the present invention, the shear strength was measured at 10 seconds and 10 minutes for the base fluid, contaminated base fluid and formulations F2-F6 prepared each with divi-divi tannins in accordance with the present invention and reference tannins, and the results of this testing are shown in FIGS. 13 and 14. As shown, contamination greatly increases the shear strength of the fluid, and no amount of reference tannin makes a substantial difference. By contrast, when 1.5 and 3.0 ppb of divi-divi tannins were added to the fluid (fluids F5 and F6 in FIG. 13) the shear strength of the fluid was greatly reduced as desired.

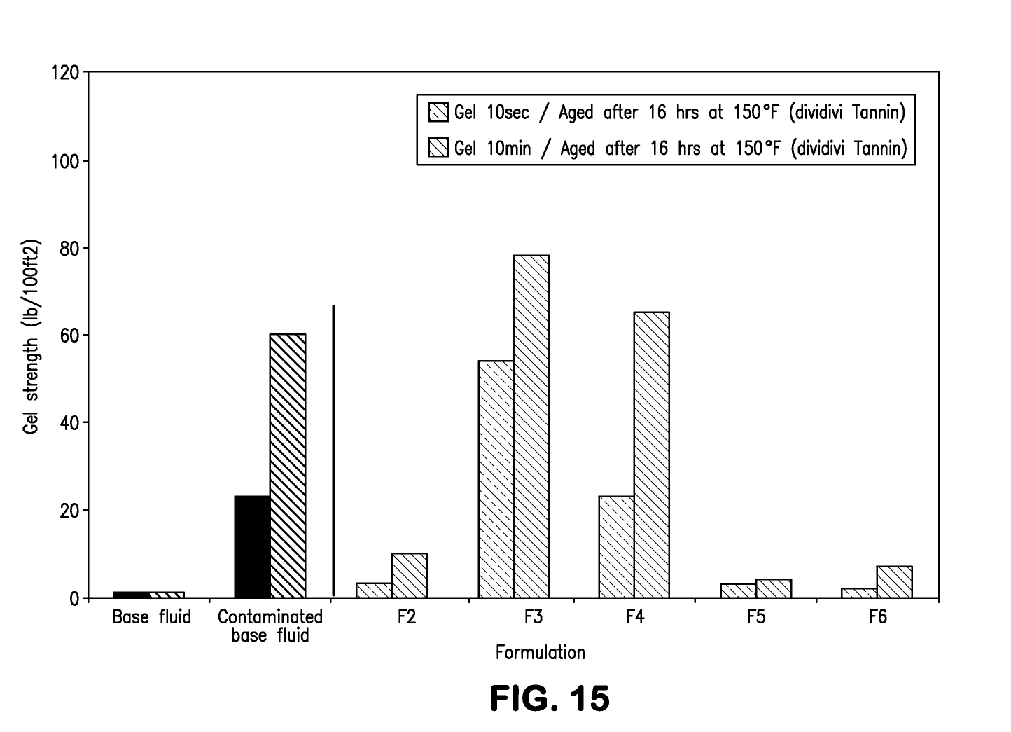

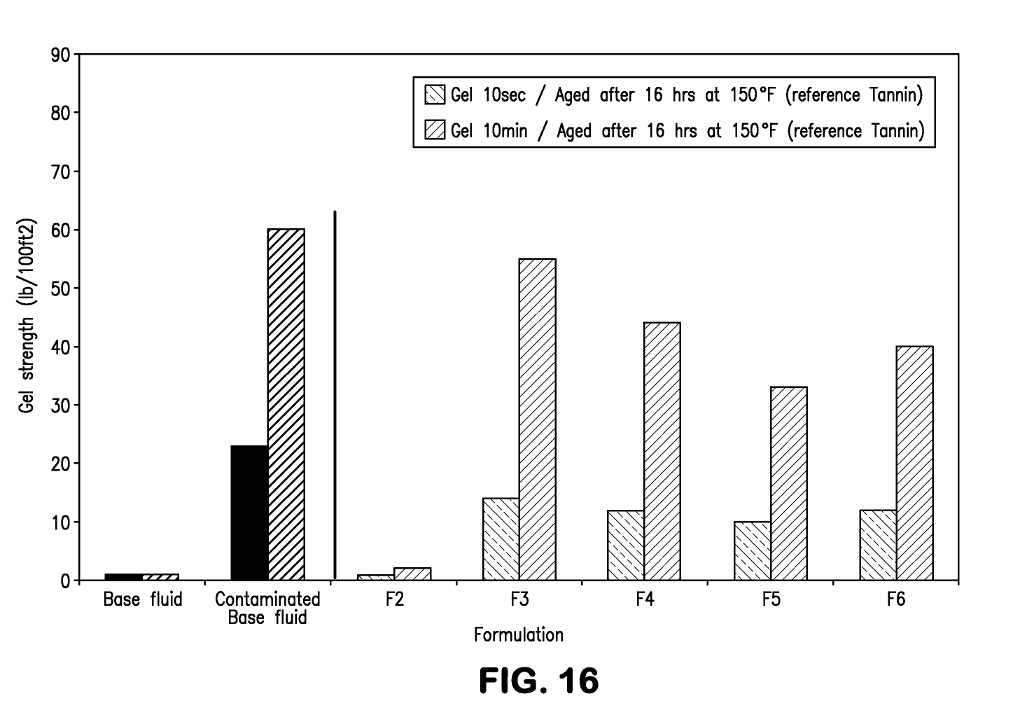

Finally, the shear strength was also evaluated after aging at 16 hours at 150° F., and the results of the aging are shown in FIG. 15 (for divi-divi tannins in accordance with the present invention) and FIG. 16 (for reference tannins). As shown, the fluids including divi-divi tannins in accordance with the present invention at concentrations of 1.5 and 3.0 ppb (fluids F5 and F6) still greatly reduce the shear strength even after aging at 16 hours. In this regard, the shear strength is reduced even as compared to the initial fluid without contamination. In the meantime, FIG. 16 shows that reference tannins did not have a significant impact on shear strength at any of the measured concentrations.

Based upon the foregoing, it is believed to be clear that a drilling fluid containing at least about 1.0 ppb of divi-divi tannins in accordance with the present invention has substantially improved properties on all parameters measured and evaluated. It is believed that this is due to divi-divi tannin acting as a deflocculant through positive redox potential, unlike the reference tannin (commercial modified tannin) operating at negative redox potential. However, both load balancing mechanisms are explicable on the model of the diffused double layer. Water-based fluids contaminated with plaster or cement containing tannin divi-divi exhibit better before and after aging deflocculant performance with an increasing amount of tannin divi-divi, between 1.0-3.0 ppb, accentuating the rheological behavior with aging. The upper limit is 3.0 ppb, set by load balancing mechanisms.

The process of obtaining the divi-divi tannin which are desired according to the invention begins with one step cleaning and drying of the fruit. Then follows a stage of milling and sieving between 325 to 100 mesh, corresponding to the particle size of 45 μ to 150 μ. The tannin powder obtained is dried in an oven at 50° C.

Through ISO 9648:1998 for the determination of soluble tannin content in sorghum, the percentage of hydrolysable tannins in the tannin extract of the fruit from divi-divi was examined. The modification of the analytical procedure consisted basically of replacing other chemical reagents that meet the same analytic functions. Then, standard solutions of tannic acid were prepared at different concentrations, and a calibration curve absorbance versus concentration of tannic acid by UV-Visible spectrophotometer was prepared at a wavelength of 525 nm in the absorbance of the samples, transferred to the standard curve and the concentration of hydrolysable tannins and tannic acid was determined.

The addition of divi-divi tannin to drilling fluid according to the invention can be done in two ways, prevention and treatment. At the preventive stage, the addition of tannin to the drilling fluid is preferably lower, for example 0.5 pounds per barrel. In the treatment stage, depending on the concentration of the contaminant, between 1.0 and 3.0 pounds per barrel can be added. All alkaline pH of 9.5-10 is preferred.

It should be appreciated that a detailed description of preferred embodiments of the present invention has been presented above. This is to be viewed as illustrative of several embodiments of the present invention but not limiting upon the actual scope of the invention, which is instead measured by the scope of the claims set forth below.

What is claimed is:

1. A conditioned, water-based drilling fluid comprising:
water-based drilling fluid; and
unmodified vegetable tannin comprising hydrolysable tannin.

2. The drilling fluid of claim 1, wherein the vegetable tannin is C. coriaria tannin.

3. The drilling fluid of claim 1, wherein the vegetable tannin has particle sizes between 45 μm and 75 μm.

4. The drilling fluid of claim 1, wherein the unmodified vegetable tannin comprises at least 65% tannin content as tannic acid.

5. The drilling fluid of claim 1, wherein the unmodified vegetable tannin comprises gallotannin-type structures.

6. The drilling fluid of claim 1, wherein the drilling fluid contains gypsum.

7. The drilling fluid of claim 1, wherein the unmodified vegetable tannin is present in an amount between 1.0 and 3.0 ppb (pounds per barrel).

8. The drilling fluid of claim 6, wherein the unmodified vegetable tannin is present in an amount between 1.0 and 3.0 ppb (pounds per barrel).

9. A method for drilling a subterranean well, comprising the steps of:
operating a drill bit in a well in the presence of a conditioned, water-based drilling fluid, wherein the drilling fluid comprises
water-based drilling fluid; and
unmodified vegetable tannin comprising hydrolysable tannin.

10. The method of claim 9, wherein the vegetable tannin is C. coriaria tannin.

11. The method of claim 9, wherein the vegetable tannin has particle sizes between 45 mm and 75 mm.

12. The method of claim 9, wherein the unmodified vegetable tannin comprises at least 65% tannin content as tannic acid.

13. The method of claim 9, wherein the unmodified vegetable tannin comprises gallotannin-type structures.

14. The method of claim 9, wherein the drilling fluid contains gypsum.

15. The method of claim 14, wherein the unmodified vegetable tannin is present in an amount between 1.0 and 3.0 ppb (pounds per barrel).

16. The method of claim 9, wherein the unmodified vegetable tannin is present in an amount between 1.0 and 3.0 ppb (pounds per barrel).
